(19) United States
(12) Patent Application Publication
(10) Pub. No.: US 2017/0255408 A1
(43) Pub. Date: Sep. 7, 2017

(54) INFORMATION PROCESSING APPARATUS, STORAGE SYSTEM, COMPUTER-READABLE RECORDING MEDIUM HAVING CONTROL PROGRAM RECORDED THEREIN, AND METHOD OF CONTROLLING STORAGE

(71) Applicant: FUJITSU LIMITED, Kawasaki-shi (JP)

(72) Inventors: Hidejirou DAIKOKUYA, Kawasaki (JP); Yoshimasa MISHUKU, Yokohama (JP); Ryota TSUKAHARA, Kawasaki (JP); Toshiaki TAKEUCHI, Nagano (JP); Akira Satou, Kawasaki (JP)

(73) Assignee: FUJITSU LIMITED, Kawasaki-shi (JP)

(21) Appl. No.: 15/437,467

(22) Filed: Feb. 21, 2017

(30) Foreign Application Priority Data
Mar. 1, 2016 (JP) 2016-038802

(51) Int. Cl. G06F 3/06

(52) U.S. Cl. CPC G06F 3/0619; G06F 3/0689; G06F 3/0665

(57) ABSTRACT

By providing a virtual integrated disk creating unit configured to create a single virtual integrated disk by virtually integrating storage areas of a plurality of storage devices, and a target setting unit configured to set a login target to which a login to the virtual integrated disk from an outside is made, the time to log in to storage areas in multiple storage device provided in another node can be reduced.

### CROSS-REFERENCE TO RELATED APPLICATION

This application is based upon and claims the benefit of priority of the prior Japanese Patent application No. 2016-038802, filed on Mar. 1, 2016, the entire contents of which are incorporated herein by reference.

### FIELD

The embodiment discussed herein relates to an information processing apparatus, a storage system, a computer-readable recording medium having a control program recorded therein, and method of controlling a storage.

### BACKGROUND

Internet Small Computer System Interface (iSCSI) is a standard based on the Internet Protocol (IP) for connecting storage devices.

FIG. 18 is a diagram depicting a configuration of a storage system compliant with the iSCSI.

A storage system 500 depicted in FIG. 18 is configured compliant with the iSCSI standard, and includes two nodes 501 and 502. Two device enclosures (DE) 503 are connected to the node 502, and each device enclosure 503 encloses one or more storage devices (hereinafter, may also be referred to as “disks”).

While not illustrated in FIG. 18, device enclosures may also be connected to the node 501.

The node 501 and the node 502 are communicatively connected to each other through Ethernet®.

The node 502 functions as a server that provides storage areas in the storage devices in the device enclosure 503.

The node 501 functions as a client (iSCSI initiator), and accesses the node 502 (iSCSI target) that is a storage server through an IP network. Therefore, the node 501 recognizes as if the storages connected to the node 502 are attached locally to the node 501.

As used herein, the procedure that enables an iSCSI initiator to access an iSCSI target through the IP network is referred to as a “login to the iSCSI target”.

In the meantime, a storage system that is configured as a distributed computing system, wherein nodes are independent from each other without sharing their resources other than the network, is referred to as a “shared-nothing type storage”.

In such a shared-nothing type storage, how to make all disks accessible from each node in the storage system will be considered.

FIG. 19 is a diagram illustrating a login procedure in a conventional shared-nothing type storage.

Similar to the storage system in FIG. 18, a shared-nothing type storage system depicted in FIG. 19 also include two nodes 501 and 502, and a device enclosure 503 is connected to the node 502.

For the sake of brevity, only one device enclosure is depicted in FIG. 19. The device enclosure 503 encloses one or more (six in FIG. 19) disks 504.

While not illustrated in FIG. 19, another device enclosure may also be connected to the node 501.

In such an iSCSI storage system, when the disks 504 are accessed across nodes with iSCSI logins in a transparent manner, login processing is required for each of the disks 504.

Specifically, when the node 501 accesses the disks 504 in the node 502, the node 501 carries out iSCSI logins to multiple iSCSI targets defined for the respective multiple disks 504 in the node 502.
Patent Document 1: Japanese Laid-open Patent Publication No. 2009-64252

In such a conventional storage system, the node 501 has to wait for login time before the node 501 can access all of the disks 504 in the node 502, and the login time is calculated as: the time to log in to a single disk×the total disk number (login count).

The time of the iSCSI logins significantly affects the apparatus startup time, and longer iSCSI login time means longer startup time. Therefore, it is desirable to reduce the time of logins.

Furthermore, every time when the node 501 logs in to iSCSI targets, some memory is consumed, and the memory consumption is calculated as: memory consumption for log in to a single disk×the total disk number (login count).

### SUMMARY

According to an aspect of the embodiments, an information processing apparatus includes a virtual integrated disk creating unit configured to create a single virtual integrated disk by virtually integrating storage areas of a plurality of storage devices; and a target setting unit configured to set a login target to which a login to the virtual integrated disk from an outside is made.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overview of transparent disk accesses to multiple disks in a storage system as one example of an embodiment;

FIG. 2 is a block diagram depicting one example of the entire configuration of a storage system as one example of an embodiment;

FIG. 3 is a diagram depicting hardware configurations of nodes in the storage system as one example of an embodiment;

FIG. 4 is a diagram depicting a functional configuration of a node in the storage system as one example of an embodiment;

FIG. 5 is a diagram exemplifying an information list obtained through an execution of the amCLI command in ServerView® RAID Manager;

FIG. 6 is a diagram exemplifying an information list obtained through an execution of the amCLI command in ServerView® RAID Manager;

FIG. 7 is a diagram exemplifying an information list obtained through an execution of the amCLI command on a specific storage device in ServerView® RAID Manager;

FIG. 8 is a diagram exemplifying grouping of storage devices in the storage system as one example of an embodiment;

FIG. 9 is a diagram exemplifying configuration tables in the storage system as one example of an embodiment;

FIG. 10 is a diagram exemplifying conversion information used for creating a concatenation volume by a concatenation volume creating unit in the storage system as one example of an embodiment;

FIG. 11 is a diagram illustrating access paths to a concatenation volume in the storage system as one example of an embodiment;

FIG. 12 is a diagram exemplifying a RAID configuration in the storage system as one example of an embodiment;

FIG. 13 is a diagram illustrating one example of a method of extracting chunks in the storage system as one example of an embodiment;

FIG. 14 is a diagram illustrating another example of a method of extracting chunks in the storage system as one example of an embodiment;

FIG. 15 is a flowchart illustrating processing in a node to which an iSCSI login is carried out in the storage system as one example of an embodiment;

FIG. 16 is a flowchart illustrating processing upon configuring a RAID in the storage system as one example of an embodiment;

FIG. 17 is a diagram illustrating processing upon accessing to a concatenation volume in the storage system as one example of an embodiment;

FIG. 18 is a diagram depicting a configuration of a storage system compliant with the iSCSI; and

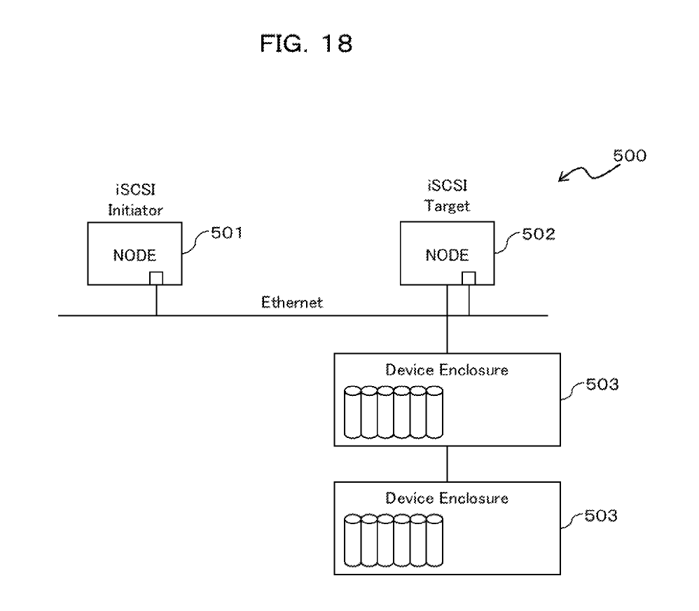

FIG. 19 is a diagram illustrating an iSCSI login procedure in a conventional shared-nothing type storage.

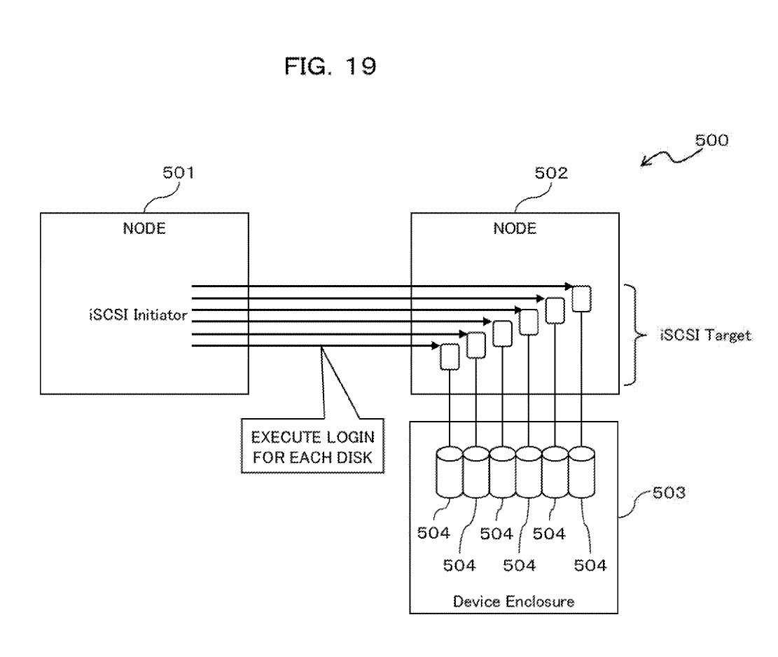

### DESCRIPTION OF EMBODIMENT(S)

Hereinafter, an embodiment of an information processing apparatus, a storage system, a control program, and a method of controlling a storage will be described with reference to the drawings. Note that the embodiment described below is merely exemplary, and it is not intended that various modifications to and applications of the technique are excluded. More specifically, the present embodiment may be embodied in various modifications without departing from the spirit thereof. In addition, it is not intended that only elements depicted in the drawings are provided, and other functions may also be provided.

(A) Overview

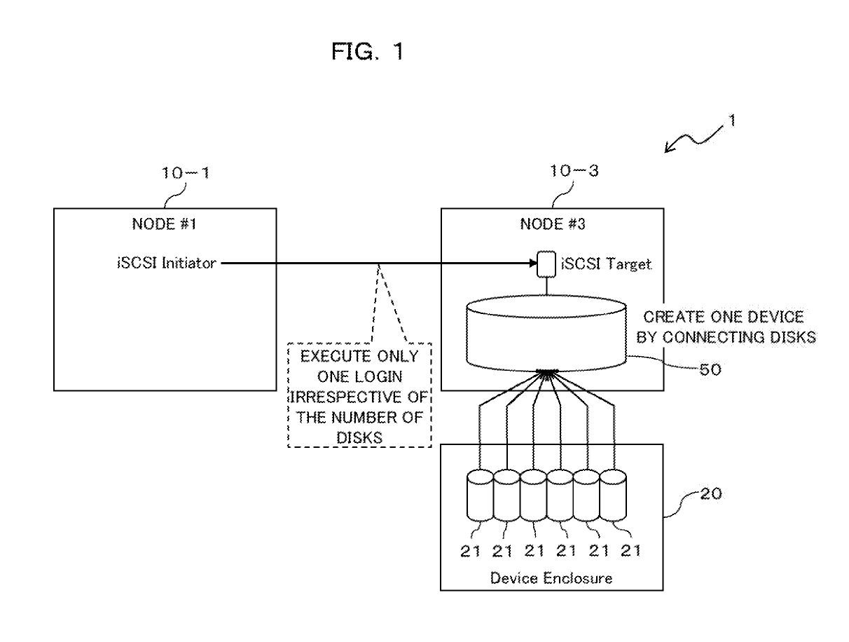

FIG. 1 is a diagram illustrating an overview of transparent disk accesses to multiple disks in a storage system as one example of an embodiment.

A storage system 1 is a shared-nothing type iSCSI storage system, and two nodes 10-1 and 10-3 are depicted in FIG. 1. These nodes 10-1 and 10-3 are connected to each other through a communication network (IP network), such as a local area network (LAN).

A device enclosure (DE) 20 is connected to the node 10-3, and the DE 20 encloses one or more (six in the example depicted in FIG. 1) storage devices 21. Hereinafter, the storage devices 21 may also be referred to as the “physical disks 21”.

While not illustrated in FIG. 1, another DE 20 may be connected to the node 10-1.

The node 10-3 virtualizes the storage devices 21 enclosed in the DE 20, thereby forming a virtual storage environment. The node 10-3 functions as a storage server that provides the other nodes 10 and devices, with virtual volumes (logical unit numbers; LUNs). Hereinafter, the virtual volumes may also be referred to as “virtual devices”.

For example, the node 10-1 functions as a client (iSCSI initiator), and accesses the node 10-3 (iSCSI target) functioning as a storage server through an IP network.

The node 10-1 can transparently access the storage devices 21 under the control of the node 10-3 by making data accesses, such as reads and writes, to a logical device provided by the node 10-3.

The node 10-3 integrates the multiple storage devices 21 mounted in the DE 20, thereby creating a single virtual disk (device, volume). Hereinafter, a single virtual disk configured by integrating the storage devices 21 is referred to as a “concatenation volume”, and denoted by the reference symbol 50. Hereinafter, the concatenation volume 50 may also be referred to as the “logical device” or “logical volume”.

The node 10-1 defines the concatenation volume 50 created by the node 10-3 as an iSCSI target, and logs in to the concatenation volume 50. In other words, only by making a single login, the node 10-1 can transparently use the multiple storage devices 21 under the control of the node 10-3 via the node 10-3.

The node 10-1 regards the concatenation volume 50 as a single large disk, and it is suffice for the node 10-1 to be aware of the total capacity of the concatenation volume 50. In addition, the node 10-1 can use the storage devices 21 in the DE 20 without being aware of the physical mount number and the configuration of the storage devices 21 in the DE 20 in the node 10-3.

(B) Configurations

(B-1) Hardware Configuration of Storage System of the Present Embodiment

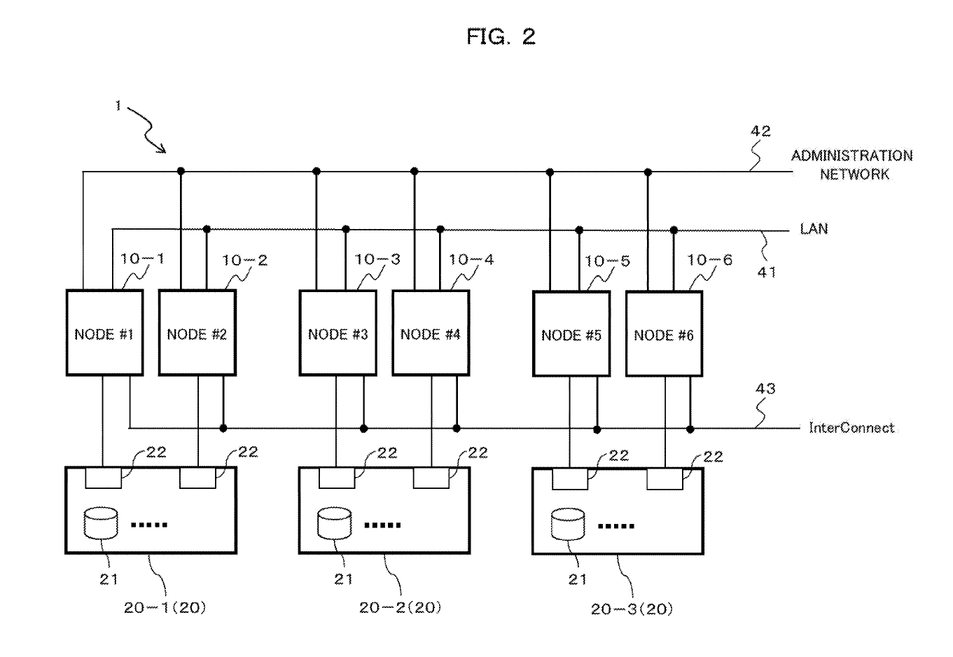

Initially, referring to FIG. 2, a hardware configuration of the storage system 1 as one example of the present embodiment will be described. FIG. 2 is a block diagram depicting one example of the entire configuration of the present storage system 1.

The storage system 1 exemplified in FIG. 2 includes multiple (six in the example depicted in FIG. 2) nodes 100-1 to 10-6 and multiple (three in the example depicted in FIG. 2) DEs 20-1 to 20-3.

Each of the nodes 10-1 to 10-6 is a control apparatus (storage control apparatus) that controls data accesses to the storage devices 21, and may also be referred to as a “controller module (CM)” or a “storage apparatus”. These nodes 10-1 to 10-6 have the same configuration. Hereinafter, reference symbols 10-1 to 10-6 are used when particular nodes are specified, while reference symbol 10 is used for referring to arbitrary nodes.

Hereinafter, the node 10-1 may also be referred to as the node #1. Similarly, the nodes 10-2, 10-3, 10-4, 10-5, and 10-6 may also be referred to as the nodes #2, #3, #4, #5, and #6, respectively.

Each node 10 is connected to a management terminal (not illustrated) via an administration network 42. Using that management terminal, an operator (e.g., system administrator) makes an input operation of various types of information. For example, the operator enters information related to various settings via the management terminal. The entered information is sent to each of the nodes 10-1 to 10-6 and other destinations.

Each node 10 is also communicatively connected to each other through the interconnect 43. The interconnect 43 is the InfiniBand (IB), for example. The interconnect is not limited to the IB, and may be the one compliant with any of other communication standards, such as the Peripheral Component Interconnect Express (PCIe), for example, and a wide variety of modifications are possible.

Each node 10 is also communicatively connected to each other through a LAN 41. This enables each node 10 to access the other nodes 10 and storage devices 21 connected to the nodes 10.

The DE 20-1 is connected to the node 10-1 and the node 10-2. Similarly, DE 20-2 is connected to the node 10-3 and the node 10-4, and DE 20-3 is connected to the node 10-5 and the node 10-6.

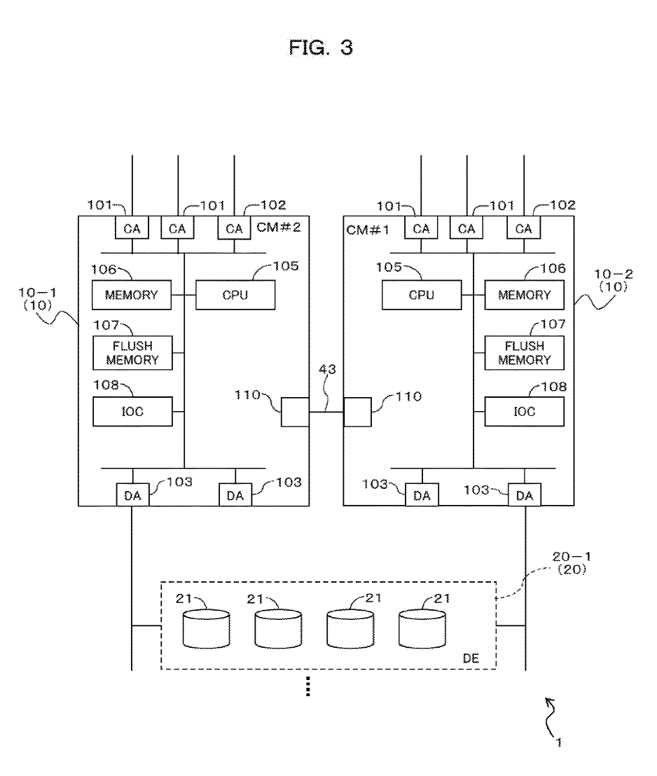

Note that DEs 20 that are directly connected to the respective nodes 10 through device adaptors (DAs) 103 (refer to FIG. 3) may be referred to as “local DEs”. Examples of the local DEs are the DE 20-1 for the nodes 10-1 and 10-2, the DE 20-2 for the nodes 10-3 and 10-4, and the DE 20-3 for the nodes 10-5 and 10-6.

The DEs 20-1 to 20-3 have the same configuration. Hereinafter, reference symbols 20-1 to 20-3 are used when particular DEs are specified, while reference symbol 20 is used for referring to arbitrary DEs.

Each DE 20 can accommodate one or more storage devices (physical disks) 21, and provides the nodes 10-1 to 10-6 with storage areas (real volumes, real storages) in the storage devices 21.

For example, each DE 20 includes multiple slots (not illustrated), and the real volume capacity can be modified where appropriate by connecting an additional storage device 21 to a slot. In addition, a redundant arrays of inexpensive disks (RAID) can be configured with multiple storage devices 21.

The storage devices 21 are storage devices (storages), such as hard disk drives (HDDs), solid state drives (SSDs), having a greater capacities than a memory 106 that will be described later, and are configured to store various types of data. Hereinafter, the storage devices may also be referred to as “drives”, “disks”, or “devices”.

The DEs 20 are connected to the respective DAs 103 in the nodes 10-1 to 10-6 (refer to FIG. 3).

Expanders 22 are devices that relay between the nodes 10 and the DE 20, and transfer data in response to a host IO. More specifically, anode 10 accesses the corresponding DE 20 through an expander 22. For example, in the DE 20-1, the node #1 is connected to one of the expanders 22, and the node #2 is connected to the other expander 22.

In the DE 20-1, the two expanders 22 are connected to the storage devices 21. As a result, in the DE 20-1, the node #1 is connected to each storage device 21 through one of the expanders 22, and the node #2 is connected each storage device 21 through the other expander 22.

In this configuration, the nodes #3-#6 can access the storage devices 21 enclosed in the DE 20-1 via two redundant routes: a route connecting through the node #1, and another route connecting through the node #2. In this manner, they configure redundant routes to the DE 20-1.

Similarly, the node #3 and the node #4 are connected to the DE 20-2, and the node #5 and the node #6 are connected to the DE 20-3.

Other nodes 10 and devices can access the storage devices 21 enclosed in the DE 20-2. Further, in the present storage system 1, the nodes #1-#4 can access the storage devices 21 enclosed in the DE 20-3 via two redundant routes: a route connecting through the node #5, and another route connecting through the node #6.

Hereinafter, a pair of two nodes 10 that are connected to one DE 20 for providing redundancy of routes to that DE 20 set forth above may be referred to as “redundant nodes” (e.g., the pair of the node #1 and the node #2, the pair of the node #3 and the node #4, and the pair of the node #5 and the node #6).

Each DE 20 is accessible from any of two nodes 10 configuring redundant nodes, thereby allowing data to be written and read to and from storage devices 21 mounted in that DE 20. More specifically, redundancy of the access routes to the storage devices 21 is provided by connecting the respective nodes 10 to each storage device 21 in the DE 20.

Furthermore, from the perspective of each node, other nodes 10 configuring redundant nodes together with that node may be referred to as “local nodes”, and other nodes 10 not configuring the redundant nodes may be referred to as “remote nodes”.

In the present storage system 1, each node 10 can access the storage devices 21 in the DEs 20 connected to the remote nodes 10 through the LAN 41, using the iSCSI.

While a single DE 20 is connected to each pair of redundant nodes 10 in the example depicted in FIG. 2 for the sake of brevity, this is not limiting and a wide variety of modifications are possible. For example, multiple DEs 20 may be connected to each pair of redundant nodes 10, or multiple DEs 20 may be connected in a cascade.

(B-2) Configurations of Nodes in the Present Embodiment

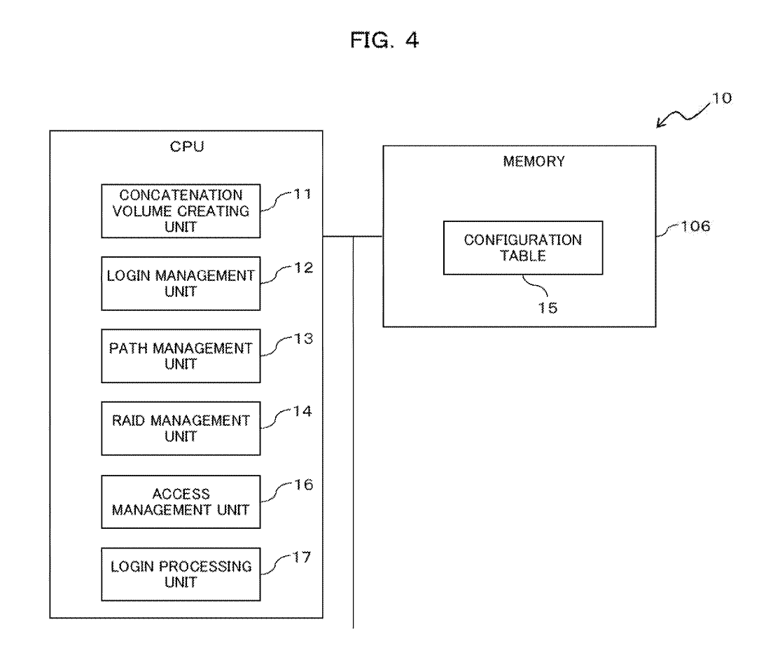

FIG. 3 is a diagram depicting hardware configurations of nodes 10 in the storage system 1 as one example of an embodiment, and FIG. 4 is a diagram depicting a functional configuration of a node 10 in the storage system 1 as one example of an embodiment.

For the sake of brevity, FIG. 3 illustrates only the nodes 10-1 and 10-2 of the multiple nodes 10 and the DE 20-1, provided in the present storage system 1, and other configurations are not illustrated.

Each node 10 is a control apparatus (controller, storage control apparatus) that controls function as a storage apparatus, and carries out a wide variety of controls, such as controls on a data access to the storage devices 21 in the DE 20 in accordance with an IO request sent from another node 10 or device (not illustrated). More specifically, each node 10 has a function as a storage server that controls a data access to the storage device 21 in response to an IO request from another node 10 or device.

In the example depicted in FIG. 3, the nodes 10-1 and 10-2 are duplicated, and the node 10-1 (the node #1) generally carries out a wide variety of controls as a primary node, for example. Upon a failure of the primary node 10-1, however, the secondary node 10-2 (the node #2) becomes a primary node to take over operations of the node 10-1.

The nodes 10-1 and 10-2 are connected to the LAN 41, via channel adapters (CAs) 101 and 102, respectively. Other nodes 10-3 to 10-6 and devices are also connected to the LAN 41. The nodes 10-1 and 10-2 receive an IO request sent from another node 10 or device, such as a read or a write, and control the storage devices 21 via the DAs 103 or the like. Further, the nodes 10 are communicatively connected to each other through an interconnect 43.

As depicted in FIG. 3, each of the nodes 10-1 and 10-2 includes CAs 101 and 102 and multiple (two in the example depicted in FIG. 3) DAs 103, and also includes a CPU 105, a memory 106, a flash memory 107, and an input/output controller (IOC) 108. The CAs 101 and 102, the DA 103, the CPU 105, the memory 106, the flash memory 107, and the IOC 108 are communicatively connected to each other through a bus, for example.

The CAs 101 and 102 are adaptors that receive data sent from the other nodes 10, a management terminal, and other devices, and send data to the other nodes 10, the management terminal, and the other devices. More specifically, the CAs 101 and 102 control inputs and outputs of data between external apparatuses, such as the other nodes 10 and devices.

Each CA 101 is a network adaptor that communicatively connects to the other nodes 10 and the management terminal, and is a LAN interface, for example. Each node 10 is connected to the other nodes 10 or devices via the CAs 101 through the LAN line in accordance with the network attached storage (NAS) standard, to receive an IO request and to send and receive data. In the example depicted in FIG. 3, two CAs 101 is provided to each of the nodes 10-1 and 10-2.

The CA 102 is a network adaptor that communicatively connects to the other nodes 10 through a storage area network (SAN), and is an iSCSI interface, for example. Each node 10 is connected the other nodes 10 and devices via the CA 102 through a communication line (not illustrated) in accordance with the SAN standard, to receive an IO request and to send and receive data. In the example depicted in FIG. 2, one CA 102 is provided to each of the nodes 10-1 and 10-2.

Each DA 103 is an interface for communicatively connecting the DE 20, the storage devices 21, and other devices. The storage devices 21 in the DE 20-1 are connected to the DAs 103 provided in each of the nodes 10-1 and 10-2, and each node 10 carries out an access control on the storage device 21, based on an IO request received from another node 10 or device.

Each node 10 writes and reads data to and from the storage devices 21 via the DAs 103.

With this configuration, data can be written and read to and from the storage devices 21 in the DE 20 from any of the nodes 10-1 and 10-2.

Note that multiple DAs 103 may be provided to each node 10, and each node 10 may be connected to the DE 20 via the multiple DAs 103.

Hereinafter, a DE 20 that is connected to a node 10 via DAs 103 may be referred to the “DE 20 under the control”, and storage devices 21 mounted in the DE 20 under the control may be referred to as the “storage devices 21 under the control”.

The interconnect 43 is connected to the communication adaptor 110, and the node 10 carried out interconnect communications with the other node 10 through the communication adaptors 110 and the interconnect 43.

The flash memory 107 is a storage device that stores programs executed by the CPU 105, various types of data, and the like.

The memory 106 is a storage device that temporarily stores various types of data and programs, and stores a control program, for example. The control program is a program executed by the CPU 105 for embodying the storage control functions of the present embodiment, and is saved in the memory 106 or the flash memory 107, for example.

Note that a part of the storage areas in the memory 106 also functions as a cache area that temporarily stores data received from another node 10, or data to be sent to another node 10. Note that the memory 106 has a higher access speed but a smaller capacity than those of the above-described storage devices (drives) 21, and is a random access memory (RAM), for example.

The IOC 108 is a controller that controls data transfers in each node 10, for example, to achieve a direct memory access (DMA) transfer for transferring data stored in the memory 106 bypassing the CPU 105.

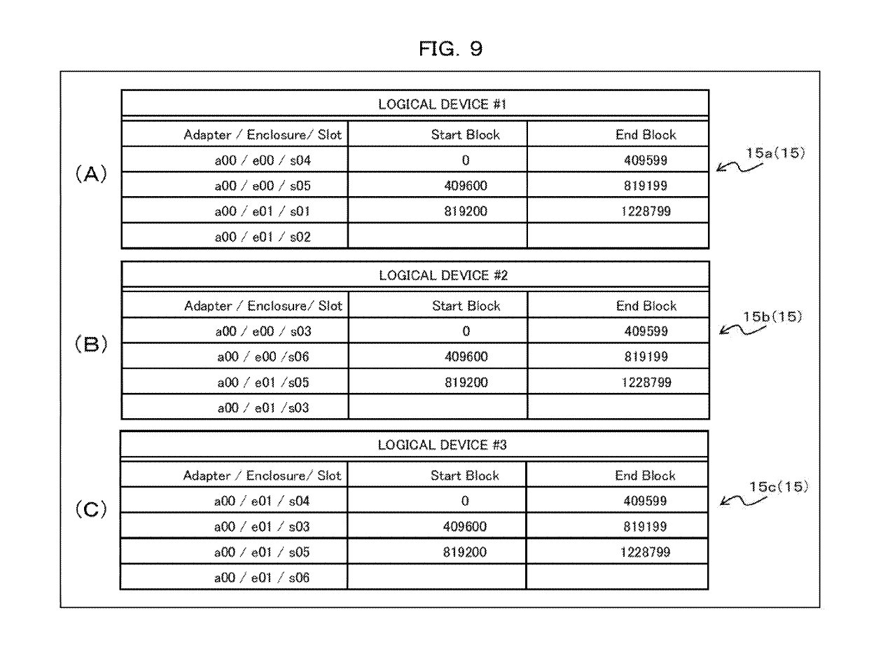

In the memory 106, configuration tables 15 are also stored. Note that the configuration tables 15 will be described later with reference to FIG. 9.

The CPU 105 is a processing apparatus that carries out various types controls and computations, and is a multi-core processor (multi-core CPU), for example. The CPU 105 embodies various functions by executing an operating system (OS) and programs stored in the memory 106, the flash memory 107, and the like.

By executing the control program, as depicted in FIG. 4, the CPU 105 functions as a concatenation volume creating unit 11, a login management unit 12, a path management unit 13, a RAID management unit 14, an access management unit 16, and a login processing unit 17.

Note that the program (control program) for embodying the functions as the concatenation volume creating unit 11, the login management unit 12, the path management unit 13, the RAID management unit 14, the access management unit 16, and the login processing unit 17 is provided in the form of a program recorded in a computer-readable recording medium, such as flexible disks, CDs (e.g., CD-ROMs, CD-Rs, CD-RWs), DVDs (e.g., DVD-ROMs, DVD-RAMS, DVD-Rs, DVD+Rs, DVD-RWs, DVD+RWs, HD DVDs), Blu-ray disks, magnetic disks, optical disks, magneto-optical disks, for example. The computer reads the program from that recording medium and transfers it to and stores it in an internal storage device or an external storage device for later use. Alternatively, the program may be recorded in a storage device (recording medium), such as a magnetic disk, an optical disk, a magneto-optical disk, for example, and may be provided from the storage device to the computer via a communication route.

Upon embodying the functions as the concatenation volume creating unit 11, the login management unit 12, the path management unit 13, the RAID management unit 14, the access management unit 16, and the login processing unit 17, the program stored in an internal storage device (the memory 106 or the flash memory 107 in the present embodiment) is executed by a microprocessor (the CPU 105) in the computer in the present embodiment. At this time, the program recorded in a recording medium may be read and executed by the computer.

The concatenation volume creating unit 11 creates a concatenation volume 50.

The concatenation volume creating unit 11 creates a concatenation volume 50 through three processing: (1) fixation of a disk device name: (2) grouping of disks; and (3) creation of a logical device. Each processing will be described below.

(1) Fixation of Disk Device Name

In a server computer, device names are generally given by the OS to disks connected to that computer in accordance with a predetermined rule.

For example, in the Linux® operating system, a device name of “/dev/sd**” (** is a variable) is set, wherein a value (e.g., 01, 02, 03, . . . , a, b, c, . . . ) indicating the order of recognition of the disk by the OS is set to the variable part “**”.

Since such a device name is assigned in accordance with the rule of the OS, a device name is not always relevant to the location where the disk is physically mounted, for example, and may be varied upon an apparatus restart. This may affect a RAID having that disk, for example.

Hereinafter, a device name of a storage device 2l specified by the OS may be referred to as the “original device name”.

In the present storage system 1, the concatenation volume creating unit 11 converts (fixes) a device name of a storage device 21, into a certain value based on the location where the storage device 21 is mounted in the DE 20 (physical mount location). Indicating the storage device 21 using its physical location in the storage system 1 prevents the disk 21 from being lost upon an apparatus restart. Hereinafter, a fixed device name set by the concatenation volume creating unit 11 for a storage device 21 is referred to as a “fixed device name”.

In the following example, it is assumed that the OS is Linux.

The concatenation volume creating unit 11 sets a fixed device name for a storage device 21, for uniquely identifying that storage device 21, using the adaptor number (No.), the enclosure number (No.), and the slot number (No.) of the storage device 21.

As used herein, the adaptor No. is an identifier for identifying a DA 103, to which a DE 20 is connected in the node 10. The enclosure No. is an identifier for identifying that DE 20. The slot No. is an identifier for identifying a slot where the storage device 21 is attached in the DE 20.

Stated differently, the concatenation volume creating unit 11 converts the device name of the storage device 21 designated by the OS, into a fixed device name indicating the location where the storage device 21 is physically mounted, using the adaptor No., the enclosure No., and the slot No.

Hereinafter, the adaptor No., the enclosure No., and the slot No. of a storage device 21 is referred to as “disk information”. The disk information indicates the location where the storage device 21 is disposed in the present storage system 1.

The concatenation volume creating unit 11 collects above-described disk information using the function of a RAID management tool, for determining a fixed device name.

For example, the concatenation volume creating unit 11 collects disk information using the amCLI command of ServerView® RAID Manager, which is a RAID management tool supplied by Fujitsu Limited.

ServerView® RAID Manager is software for monitoring, administrations, maintenances, and setting of RAID controllers, and hard disks and logical drives connected to the RAID controllers.

The concatenation volume creating unit 11 obtains disk information set forth above, using the monitoring and administration functions of inter-disk routes of ServerView® RAID Manager.

Specifically, the concatenation volume creating unit 11 collects disk information using the amCLI command of ServerView® RAID Manager.

The amCLI command is a command line tool of ServerView® RAID Manager, and outputs an information list when the option “−l” is appended.

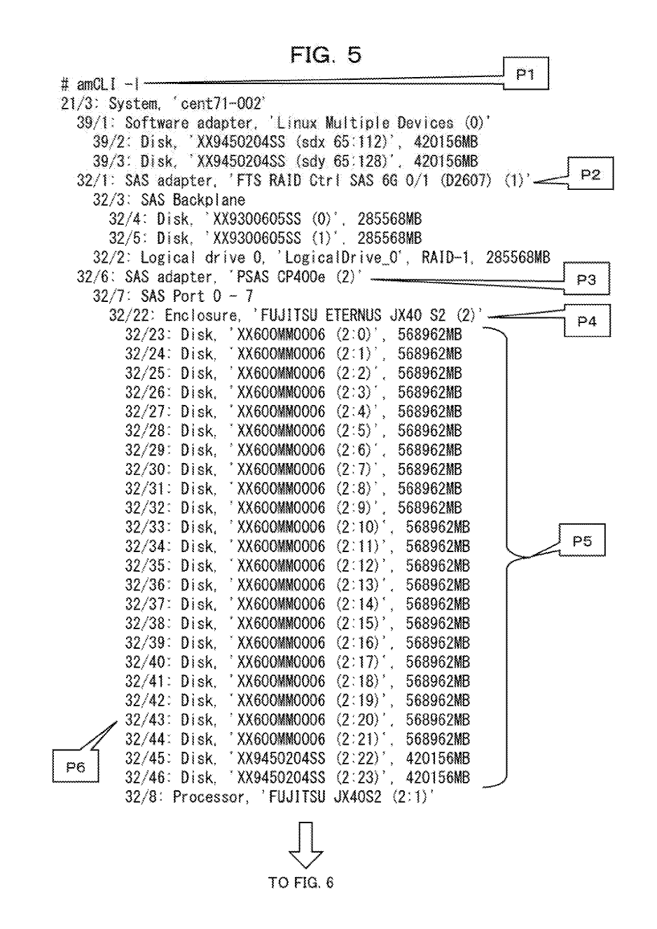

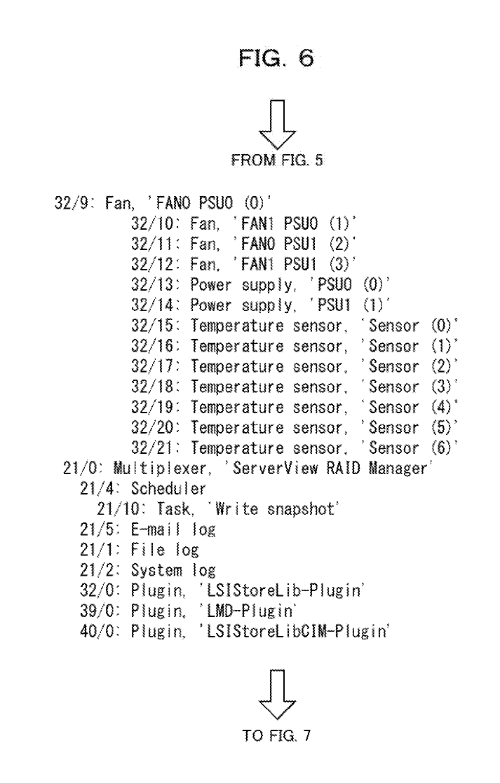

FIGS. 5 and 6 are diagrams exemplifying an information list obtained through an execution of the amCLI command in ServerView® RAID Manager, and FIG. 6 depicts an information list following that indicated in FIG. 5.

The information list exemplified in FIGS. 5 and 6 is obtained by executing the command “amCLI −l” (refer to the reference symbol P1 in FIG. 5).

This information list indicates information about a Serial Attached SCSI (SAS) adaptor indicated by “FTS RAID Ctrl SAS 6G 0/1 (D2607) (1)” (refer to the reference symbol P2 in FIG. 5) and a SAS adaptor indicated by “PSAS CP400e (2)” (refer to the reference symbol P3 in FIG. 5).

The values indicated by the numbers in parentheses in the ends of those lines correspond to adaptor Nos. More specifically, for example, the adaptor No. of the SAS adaptor indicated by “PSAS CP400e (2)” (refer to the reference symbol P3 in FIG. 5) is “02”.

To the SAS adaptor “PSAS CP400e (2)”, a DE 20 indicated by “FUJITSU ETERNUS JX40 S2 (2)” is connected (refer to the reference symbol P4 in FIG. 5).

To the DE 20 indicated by “FUJITSU ETERNUS JX40 S2 (2)”, 24 storage devices 21 are mounted (refer to the reference symbol P5 in FIG. 5).

The concatenation volume creating unit 11 collects disk information for each of those storage devices 21, and carries out fixation of respective disk names.

An example will be described, wherein disk information for the storage device 21 denoted by the identifier “32/43” (refer to the reference symbol P6 in FIG. 5), among the 24 storage devices 21 mounted on the SAS adaptor “PSAS CP400e (2)”, is collect.

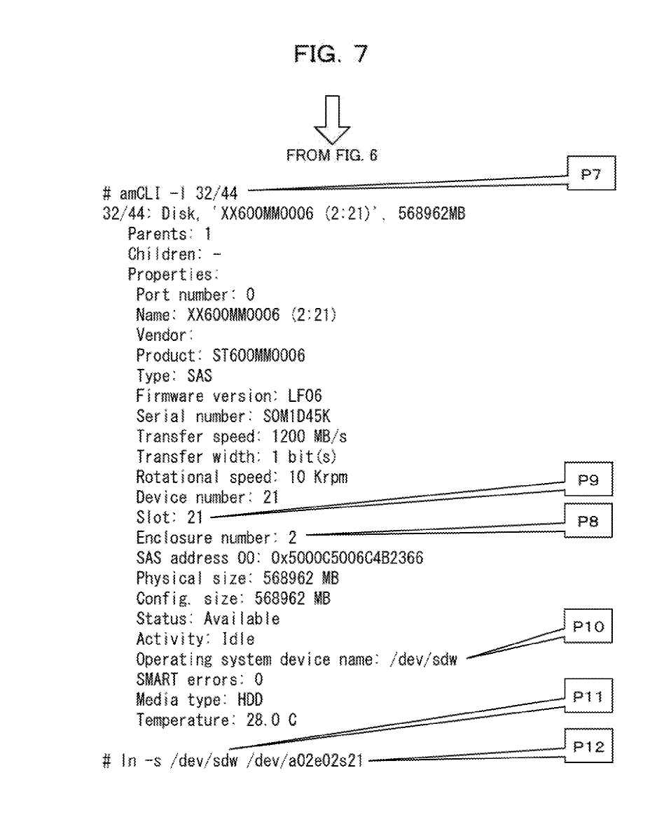

FIG. 7 is a diagram exemplifying an information list obtained through an execution of the amCLI command in ServerView® RAID Manager for the particular storage device 21. FIG. 7 depicts an example wherein disk information of the storage device 21 denoted by the identifier “32/43” is collected.

The concatenation volume creating unit 11 executes the command “amCLI −l 32/44” by appending the identifier “32/44” for identifying the storage device 21, for which disk information is to be collected (refer to the reference symbol P7 in FIG. 7).

As a result, as depicted in FIG. 7, an information list for the storage device 21 identified by the identifier “32/43” is obtained.

The information list exemplified in FIG. 7 also includes the enclosure No. of a DE 20 in which the storage device 21 identified by the identifier “32/43” is mounted (refer to the reference symbol P8 in FIG. 7), and the slot No. of a slot to which the storage device 21 is attached in that DE 20 (refer to the reference symbol P9 in FIG. 7).

This information list also includes an original device name of the storage device 21 specified by the OS (refer to the reference symbol P10 in FIG. 7).

Since the information lists exemplified in FIGS. 5-7 is structured in accordance with a predetermined format, particular information can be readily extracted from the information lists.

The concatenation volume creating unit 11 sets a fixed device name using device information for a storage device 2l collected as described above.

Specifically, the concatenation volume creating unit 11 sets a fixed device name, in which collected device information (adaptor No., enclosure No., and slot No.) of a storage device 21 is incorporated.

For example, for a storage device 21 with an adaptor No. of XX, an enclosure No. of YY, and a slot No. of ZZ, the concatenation volume creating unit 11 sets the string “aXXeYYsZZ” as its fixed device name.

In the case of the storage device 21 identified by the identifier “32/43” exemplified in FIGS. 5-7, an adaptor No. is 02, an enclosure No. is 02, and a slot No. is 21. In such a case, the concatenation volume creating unit 11 determines a fixed device name of the storage device 21 identified by the identifier “32/43” to be “a02e02s21”.

The concatenation volume creating unit 11 sets a fixed device name to a storage device 21 by establishing a symbolic link for the original device name of that storage device 21 to the determined fixed device name of the storage device 21.

For example, the concatenation volume creating unit 11 sets a fixed device name to a storage device 21, using the ln command.

The ln command is a command of Linux for linking a file or a directory. The concatenation volume creating unit 11 executes the ln command “ln −s/dev/sd** aXXeYYsZZ”, to set a fixed device name of “aXXeYYsZZ” to a disk 21 having a original device name of “/dev/sd**”.

The disk access to device name of “aXXeYYsZZ” is handled as a disk access to a disk 21 having an device name of “/dev/sd**” by executing the ln command.

In the example depicted in FIG. 7, by executing the ln command “ln-s/dev/sdw a02e02s21”, the concatenation volume creating unit 11 carries out a symbolic link training of “/dev/sdw” (refer to the reference symbol P11 in FIG. 7) to a fixed device name of “a02e02s21” (refer to the reference symbol P12 in FIG. 7). As a result, the fixed device name “a02e02s21” is set to the disk 21 having the original device name “/dev/sdw”.

(2) Grouping of Disks

The concatenation volume creating unit 11 also manages storage devices 21 under the control by dividing them into multiple groups.

In the present embodiment, the concatenation volume creating unit 11 manages storage devices 21 under the control by classifying them into three groups according to their disk access performances.

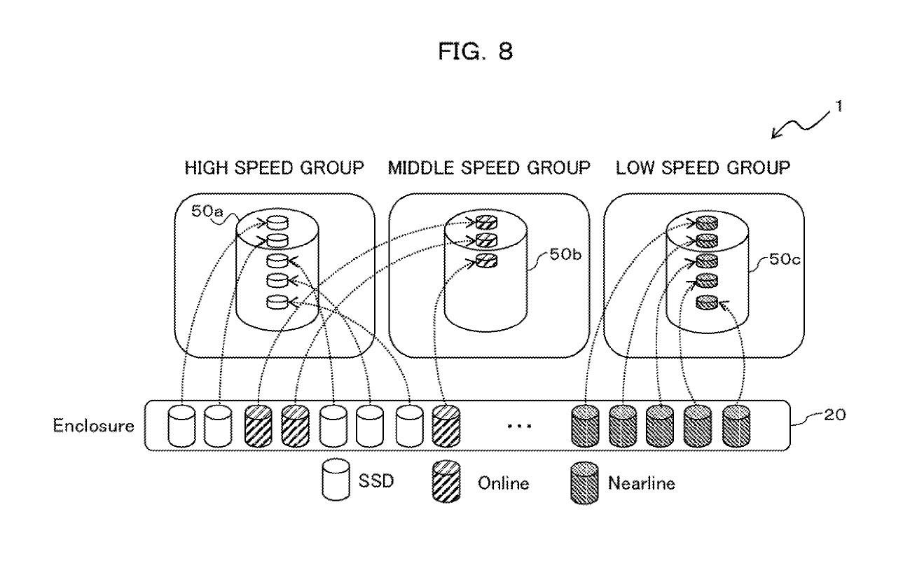

FIG. 8 is a diagram exemplifying grouping of storage devices 21 in the storage system 1 as one example of an embodiment.

In the example depicted in FIG. 8, three groups of “high speed”, “middle speed”, and “low speed” are depicted, and storage devices 21 of multiple types mounted in a DE 20 are classified into the three groups.

Here, SSDs are classified into the high speed group. Online disks and near line disks are classified into the middle speed group and the low speed group, respectively.

Near line disks are NASs in which Serial Attachment (SATA) hard disks are mounted, for example. Online disks are disks that are neither SSDs nor near line disk.

The concatenation volume creating unit 11 creates a concatenation volume 50 for each of these groups. More specifically, a concatenation volume 50 is created from disks 21 of the same group.

If a concatenation volume 50 are created by simply bundling all disks in a DE 20, the performance of the concatenation volume 50 would be reduced due to the difference in the disk types because of the bottleneck induced by slower-rotation disks. For example, upon configuring a RAID, an expected performance of the RAID may not be achieved.

Hence, in the present storage system 1, disks have been grouped into the high speed group, middle speed group, and low speed groups in advance, and respective concatenation volumes 50 are created for those groups.

(3) Creation of Logical Device

The concatenation volume creating unit 11 creates a concatenation volume 50 that is a logical device, using a fixed device name of each storage device 21. At this time, the concatenation volume creating unit 11 creates a concatenation volume 50 for each group from storages devices 21 in the same group, as described above.

The concatenation volume creating unit 11 creates a single logical volume (concatenation volume 50) by concatenating storage areas of multiple storage devices 21. The concatenation volume creating unit 11 uses configuration tables 15 for creating concatenation volumes 50.

FIG. 9 is a diagram exemplifying configuration tables 15 in the storage system 1 as one example of an embodiment. FIG. 9 depicts three configuration tables 15 for the respective three groups described above. For example, the reference symbol (A) denotes a configuration table 15a for the high speed group, the reference symbol (B) denotes a configuration table 15b for the middle speed group, and the reference symbol (C) denotes a configuration table 15c for the low speed group.

Hereinafter, reference symbols 15a, 15b, and 15c are used when a particular configuration table among the multiple configuration tables are specified, while reference symbol 15 is used for referring to arbitrary configuration tables.

A concatenation volumes 50 is generated by concatenating storage areas in multiple storage devices 21 in the same group.

Each configuration table 15 indicates storage areas in the corresponding concatenation volume 50, allocated to each of multiple storage devices 21 configuring that concatenation volume 50.

Each configuration table 15 is generated by relating disposed location information, a start block, and an end block of each of multiple storage devices 21 in the same group.

As set forth above, the disposed location information of a storage device 21 is defined by a combination of an adaptor No. (Adapter), an enclosure No. (Enclosure), and a slot No. (Slot), which indicate the location of the storage device 21. The information are included in the fixed device name of that storage device 21.

The disposed location information enables the disposed location of the storage device 21 in the present storage system 1 to be identified, and hence any storage device 21 mounted in the DE 20 can be identified accordingly.

The start block and the end block indicate addresses (logical addresses) of an area allocated in a created concatenation volume 50. The start block and the end block are the start address and the end address of a storage area in the concatenation volume 50 allocated to that storage device 21, respectively.

For example, the logical device #1 denoted by the reference symbol (A) in FIG. 9 is constructed from three storage devices 21. The address area 0-409599 of the logical device #1 corresponds to the storage device 21 identified by “a00/e00/s04”, the address area 409600-819199 of the logical device #1 corresponds to the storage device 21 identified by “a00/e00/s05”, and the address area 819200-1228799 of the logical device #1 corresponds to the storage device 21 identified by “a00/e01/s01”. The volume creating unit 11 obtains information of those storage devices 21 provided in the present storage system 1. The concatenation volume creating unit 11 then sets fixed device names of the respective storage devices 21 and collects information of the storage devices 21, such as the capacities of the storage areas.

For concatenation volumes 50 (logical volumes) to be created, a system administrator or another user has set multiple storage devices 21 to be used to construct those concatenation volumes 50, and storage areas and the like in the concatenation volumes 50, to be allocated to those storage devices 21, in advance.

The concatenation volume creating unit 11 creates configuration tables 15 using such information. More specifically, information relating logical devices and physical disks is registered in the configuration tables 15.

The configuration tables 15 can be regarded as information for administrating all logical devices in the present storage system 1. As will be described later, once a concatenation volume 50 (logical device) is created, information in the configuration table 15 is used as configuration information of that logical device. For example, the access management unit 16 looks up the configuration information as mapping information, and accesses a storage device (physical disk) 21 based on a data access made to the concatenation volume 50.

The concatenation volume creating unit 11 stores the generated configuration tables 15 in a non-volatile storage area, such as the flash memory 107. Accordingly, the configuration can be maintained even after anode 10 is powered off and is then powered on.

The concatenation volume creating unit 11 creates logical devices (concatenation volumes 50), using the configuration tables 15 described above.

In the present embodiment, the concatenation volume creating unit 11 generates conversion information using the configuration tables 15, and then creates the logical devices (concatenation volumes 50) using the conversion information.

In the present embodiment, the concatenation volume creating unit 11 creates conversion information having a file name of “online_contact_table”, for example.

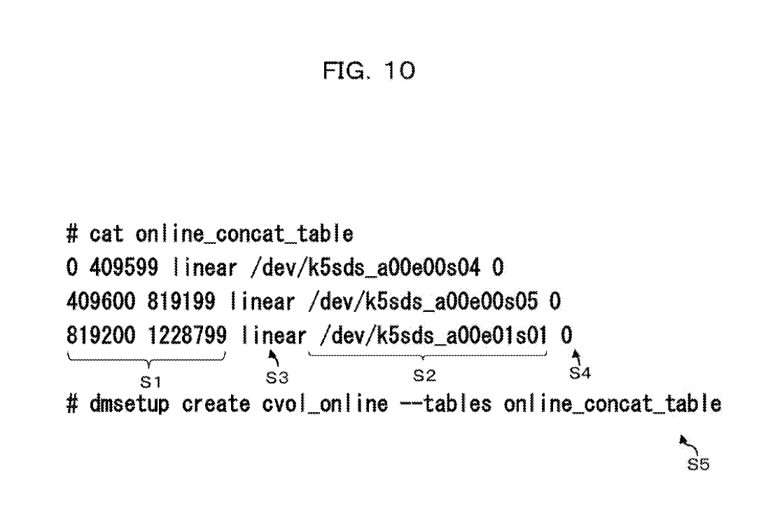

FIG. 10 is a diagram exemplifying conversion information used for creating a concatenation volume 50 by the concatenation volume creating unit 11 in the storage system 1 as one example of an embodiment.

The command lines depicted in FIG. 10 represents an example wherein the content of the file “online_contact_table” is displayed by the cat command. Further, in the example depicted in FIG. 10, a concatenation volume 50 corresponding to the logical device #1 denoted by the reference symbol (A) in FIG. 9 is created, and the device name of the created concatenation volume 50 is “cool_online”.

In lines 1-3 in the file “online_contact_table” depicted in FIG. 10, the values in the first column and the second column (refer to the reference symbol S1 in FIG. 10) indicate start blocks and end blocks of storage devices 21 configuring the logical device #1. The values in the fourth column (refer to the reference symbol S2 in FIG. 10) indicate fixed device names of the storage devices 21 configuring the logical device #1.

Furthermore, the third column contains the constant “linear” for embodying the function to concatenate strings before and after that value (refer to the reference symbol S3 in FIG. 10).

The fifth column contains device offset values, to which a constant of “0” is set (refer to the reference symbol S4 in FIG. 10).

The concatenation volume creating unit 11 creates conversion information (online_contact_table) by entering the device name of a concatenation volume 50 to be created, the addresses of start blocks and end blocks of multiple storage devices 21 configuring the concatenation volume 50, fixed device names of the respective storage devices 21, into a template for “online_contact_table” which has been set in advance, for example.

For example, a logical device (concatenation volume 50) can be defined by the “dmsetup” command in Linux.

Specifically, the concatenation volume creating unit 11 creates the concatenation volume 50 by executing the command “dmsetup create cvol_online-tables online_contact_table” (refer to the reference symbol S5 in FIG. 10), for loading the generated “online_contact_table” to the dmsetup command.

For constructing a logical device, the device name and the block addresses (start block and end block) of a concatenation volume 50 are specified in that command. The command is repeatedly executed while shifting the start block by the capacity of the disk to generate a map of the device.

The login management unit 12 creates an iSCSI target for a concatenation volume 50 created by the concatenation volume creating unit 11. The login management unit 12 also processes a login (iSCSI login) in response to a login request from another node 10 or device to the created iSCSI target.

Note that generation of iSCSI targets and processing of iSCSI logins can be embodied using well-known techniques, and detailed descriptions therefor will be omitted.

The path management unit 13 manages access paths to a logical device (concatenation volume 50).

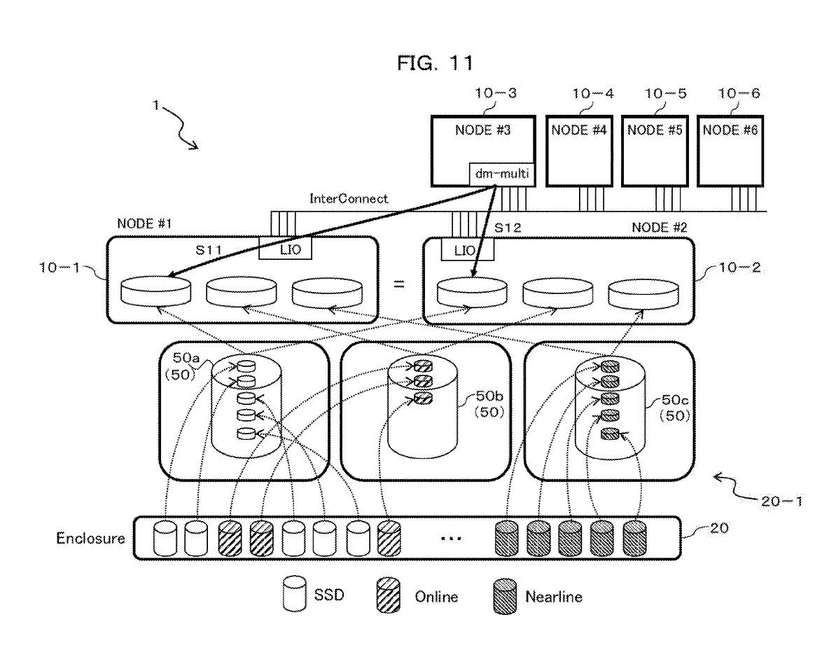

FIG. 11 is a diagram illustrating access paths to a concatenation volume 50 in the storage system 1 as one example of an embodiment.

In the example depicted in FIG. 11, the concatenation volumes 50a, 50b, and 50c are constructed using storage devices 21 in the DE 20 connected to the nodes #1 and #2 configuring redundant nodes.

Those concatenation volumes 50a, 50b, and 50c can be accessed from each of the nodes #1 and #2 through the interconnect 43.

Hence, the concatenation volumes 50a, 50b, and 50c can be connected from the remote nodes #3-#6 through two paths: a path via the node #1 (refer to the reference symbol S11 in FIG. 11) and another path via the node #2 (refer to the reference symbol S12 in FIG. 11), thereby defining a multi-path configuration.

In such a multi-path configuration, the path management unit 13 makes failover setting such that, when one of nodes 10 (e.g., the node #1) fails, the concatenation volumes 50a, 50b, and 50c can be accessed via the other node 10 (e.g., the node #2).

In the multi-path configuration where one logical device (the concatenation volume 50a, 50b, or 50c) is accessible through multiple nodes 10 (e.g., the redundant nodes #1 and #2) as described above, nodes 10 configuring redundant nodes configure the same concatenation volume 50.

For example, the node #1 and the node #2 connect to the same DE 20-1, and are accessible to the same storage devices 21. Hence, results of processing of the grouping of disks and the creation of logical devices described above by the concatenation volume creating unit 11 are identical for the node #1 and the node #2.

Specifically, in each of the nodes 10 (the nodes #1 and #2) configuring redundant nodes, by looking up the same configuration table 15, the concatenation volume creating unit 11 creates a concatenation volume 50 (logical device) in which disks are arranged in the same order and in the same disk sizes. For achieving this, the same configuration table 15 may be stored in the multiple nodes 10 in advance, such that the multiple nodes 10 can share that configuration table 15.

In this configuration, when a concatenation volume 50 of any of nodes 10 configuring redundant nodes is accessed from an arbitrary node 10, the same storage device 21 is accessed and the consistency is ensured.

The RAID management unit 14 configures a RAID from multiple logical devices, and controls storage devices 21 configuring the RAID. More specifically, the RAID management unit 14 sets a redundant configuration with multiple concatenation volumes 50.

Note that a configuration and management of a RAID by the RAID management unit 14 can be achieved using well-known techniques, and detailed descriptions therefor will be omitted.

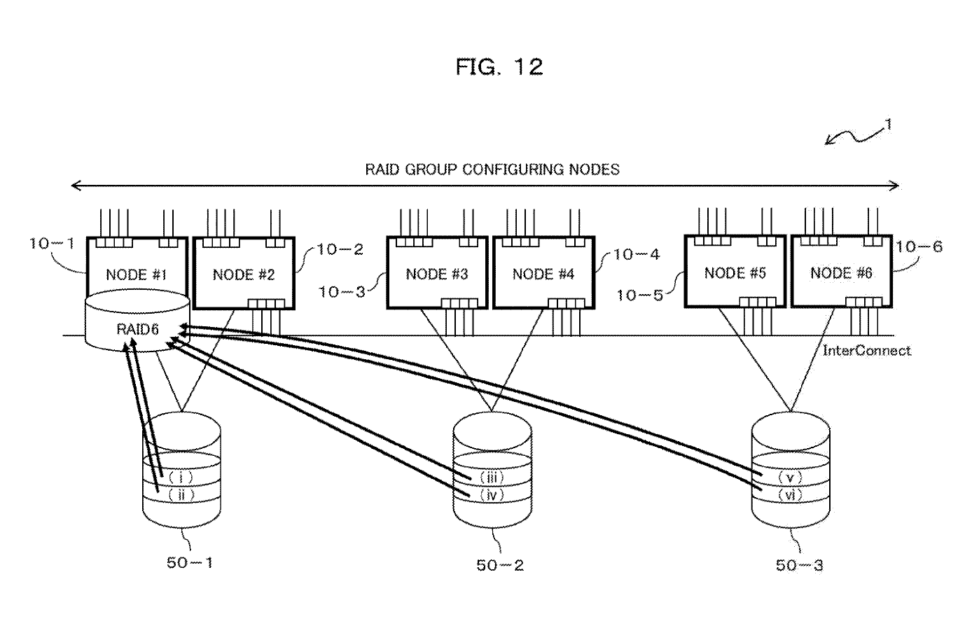

FIG. 12 is a diagram exemplifying a RAID configuration in the storage system 1 as one example of an embodiment.

In the example depicted in FIG. 12, the node #1 configures a RAID of RAID 6 (4D+2P) with areas in concatenation volumes 50-1, 50-2, and 50-3 (refer to the reference symbols (i)-(vi)). The concatenation volume 50-1 is constructed by the redundant nodes #1 and #2, and the concatenation volume 50-2 is constructed by the redundant nodes #3 and #4. The concatenation volume 50-3 is constructed by the redundant nodes #5 and #6.

As set forth above, the concatenation volumes 50 are configured by bundling multiple storage devices 21, which are physical disks. Thus, for providing data with redundancy, the RAID management unit 14 extracts chunks of the same size from multiple logical devices, and configures a RAID such that redundancy is provided among those chunks.

Note that the chunk size may be set to an arbitrary value as long as it does not reach the capacity of a logical device. It is possible for the RAID management unit 14 to extract a chunk of a necessary size from each concatenation volume 50, to dynamically configure a RAID in an arbitrary RAID configuration.

As set forth above in the “(3) Creation of Logical Device” section, relationships between logical devices and physical disks are stored in the configuration tables 15. Accordingly, for an ordinary input/output (IO) processing, physical disks corresponding to the RAID configuration are to be searched for. Conversely, when a disk failure or another error occurs, processing, such as a rebuild, is executed by looking up the configuration tables 15 to determine which RAID is to be configured from the physical disk.

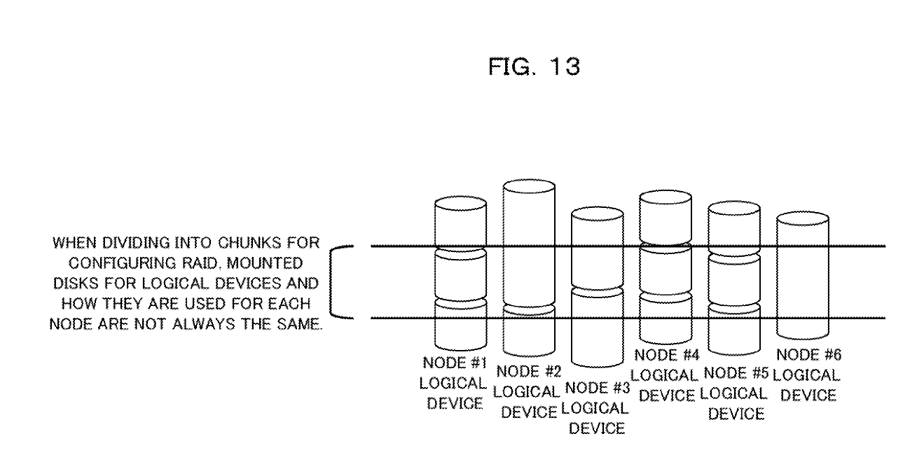

FIG. 13 is a diagram illustrating one example of a method of extracting chunks in the storage system 1 as one example of an embodiment.

When there is no limitation of the type and capacity of storage devices 21 to be mounted in each DE 20, and there is no limitation of the chunk size, mounted disks for logical devices and how they are used for each node are not always the same when dividing into chunks for configuring a RAID, as depicted in FIG. 13.

Even in such a situation, no issue arises for normal accesses. Even when an access across physical disks is requested, the request is divided into IOs, which are then issued to multiple physical disks (storage devices 21) by looking up the configuration tables 15, for example.

When a logical device is constructed from physical disks for configuring a RAID, the size of the physical disks may be adjusted to the chunk size.

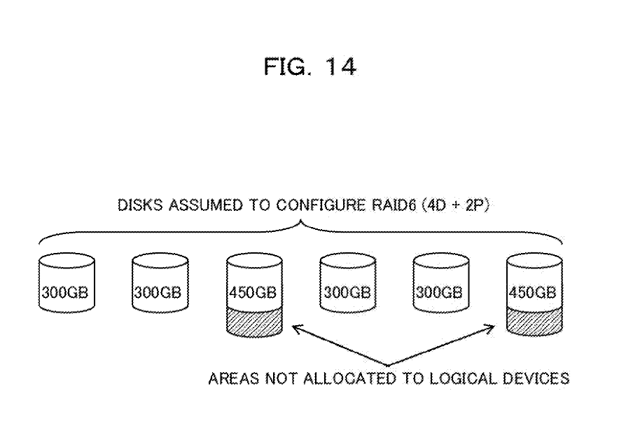

FIG. 14 is a diagram illustrating another example of a method of extracting chunks in the storage system. 1 as one example of an embodiment.

In the example depicted in FIG. 14, the chunk size extracted from the storage devices 21 is set to 300 GB. More specifically, unused (trimming) sections are provided to set the multiple physical disks to the same capacity, and only an area of 300 GB is used in 450-GB disks, and remaining 150-GB areas are not allocated to any logical devices and remain unused.

Such trimming is advantageous in that it is easier to identify which disk constructs which RAID. Particularly when disks are trimmed into the size that are multiples of the chunk size, a physical disk is uniquely determined for a chunk.

The trimming also have additional advantages of easier management of a rebuild and calculation of the progress. All rebuilds are executed with respect to physical disks. Hence, trimming to align physical disk borders with chunk borders is advantageous in that a rebuild operation is initiated in a unit of chunk and the progress is easily calculated by summing completed and uncompleted chunks.

On the other hand, not carrying out trimming also have an advantage in that there is no need to take the RAID configuration and the configuration of physical disks into considerations. Another advantage is in that the entire disk capacity is used and thus no area is wasted.

The access management unit 16 manages data accesses to logical devices (concatenation volumes 50). For example, when a data access (e.g., a read or a write) to a concatenation volume 50 is made from another node 10 or device, the access management unit 16 makes a data access to the storage device 21 (physical disk) corresponding to a storage area in a concatenation volume 50.

For example, the access management unit 16 has mapping information (not illustrated) in the memory 106 or the like, which relates logical block addresses (LBAs) of storage areas in a concatenation volume 50, to LBAs of storage areas in multiple storage devices 21 configuring that concatenation volume 50.

The mapping information relates a first LBA to an LBA (second LBA) in a physical disk 21, and is configured as a conversion table, for example.

Hereinafter, an LBA in the concatenation volume 50 may be referred to as a “first LBA”, and a corresponding LBA in the physical disk 21 may be referred to a “second LBA”.

By looking up the mapping information, the access management unit 16 obtains a second LBA based on a first LBA contained in a data access from another node 10 or device to a concatenation volume 50, for example.

Using the obtained second LBA, the access management unit 16 then accesses a storage device 21 (physical disk) configuring that concatenation volume 50.

The login processing unit 17 makes a login (iSCSI login) to a logical disk constructed in another node 10. Note that an iSCSI login to a logical disk can be embodied using well-known techniques, and detailed descriptions therefor will be omitted.

(C) Operations

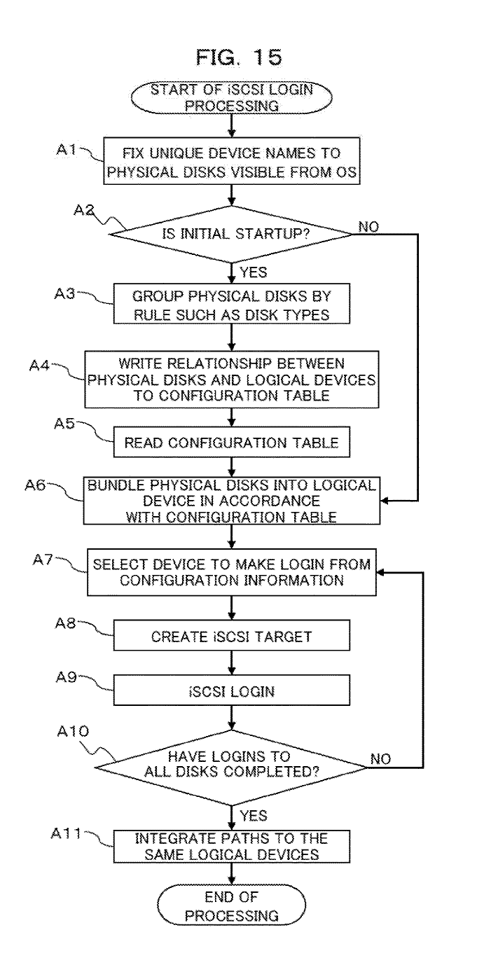

Processing in a node 10 to which an iSCSI login is made, in the storage system 1 as one example of an embodiment configured as described above, will be described with reference to a flowchart (Steps A1-A11) depicted in FIG. 15.

FIG. 15 depicts processing when an iSCSI login is carried out from one remote node 10 (e.g., the node #1) to all logical devices in another node 10 (e.g., the node #3).

After iSCSI login processing is initiated in the remote node 10, in Step A1, the concatenation volume creating unit 11 fixes device names (disk device names) of storage devices 21 (physical disks) visible from the OS.

The concatenation volume creating unit 11 sets the fixed device names indicating the disposed locations of the storage devices 21, to original device names that have been specified to the storage devices 21 in the format of “/dev/sd**” by the OS (e.g., Linux) for example.

In Step A2, the concatenation volume creating unit 11 checks whether or not it is an initial startup.

When it is an initial startup as a result of the check (refer to the YES route from Step A2), the concatenation volume creating unit 11 classifies storage devices 21 in the local DE 20 into groups in Step A3. More specifically, the storage devices 21 in the local DE 20 are classified into “high speed”, “middle speed”, and “low speed” groups.

In Step A4, the concatenation volume creating unit 11 writes the relationships between the physical disks and the logical devices to configuration tables 15. The generated configuration tables 15 are stored in the flash memory 107 or the like.

In Step A5, the concatenation volume creating unit 11 reads the configuration tables 15 relating the physical disks and the logical devices from the flash memory 107 or the like, and stores (saves) them in the memory 106.

In Step A6, the concatenation volume creating unit 11 bundles the multiple storage devices 21 (physical disks) into logical disks, based on the configuration tables 15. In other words, the concatenation volume creating unit 11 creates concatenation volumes 50.

Otherwise, when it is not an initial startup as the result of the check in Step A2 (refer to the NO route from Step A2), the flow transitions to Step A6.

In Step A7, the login management unit 12 selects a logical device (concatenation volume 50) to be logged in, based on configuration information for managing all logical devices in the node #3.

The login management unit 12 creates an iSCSI target for the selected logical device in Step A8, and carries out iSCSI login processing in Step A9.

In Step A10, the login management unit 12 checks whether iSCSI logins to all of the logical devices in the node #3 have been completed. When there is any logical device that has not been logged in as the result of the check (refer to the NO route from Step A10), the flow returns to Step A7.

When all of the logical devices have been logged in (refer to the YES route from Step A10), the flow transitions to Step A11.

In Step A11, the path management unit 13 makes failover setting for that concatenation volume 50 such that, when one of nodes 10 (e.g., the node #3) configuring redundant nodes fails, the concatenation volume 50 can be accessed via the other node 10 (e.g., the node #4). Thereafter the processing ends.

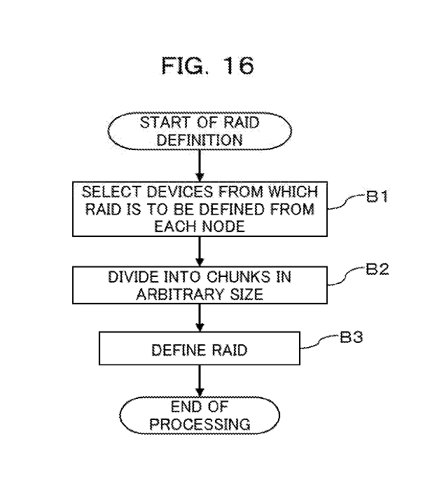

Next, processing upon constructing a RAID in the storage system in the storage system 1 as one example of an embodiment will be described with reference to a flowchart (Steps B1-B3) depicted in FIG. 16.

The processing is executed after iSCSI logins are carried out from a remote node 10.

In Step B1, the RAID management unit 14 selects logical devices (concatenation volumes 50) from which a RAID is to be configured, from each node 10.

In Step B2, the RAID management unit 14 extracts chunks of an arbitrary size, from the selected concatenation volumes 50.

In Step B3, the RAID management unit 14 configures a RAID from the extracted chunks, and the processing ends.

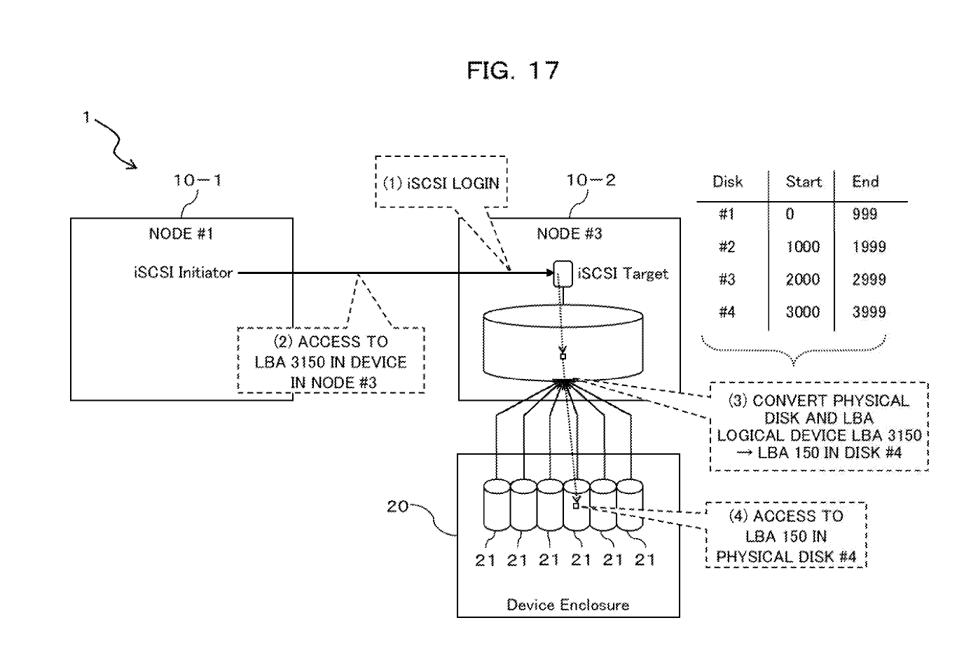

FIG. 17 is a diagram illustrating processing upon accessing to a concatenation volume 50 in the storage system 1 as one example of an embodiment.

For accessing a concatenation volume 50 in the node #3 as an iSCSI target as an extension of a host access from the node #1, the following processing (1)-(4) is executed.

(1) The node #1 logs in to the iSCSI target of the concatenation volume 50 in the node #3.

(2) The node #1 accesses the concatenation volume 50 by specifying the concatenation volume 50 in the node #3, which is a remote node, and the first LBA of the concatenation volume 50.

For example, the node #1 accesses a first LBA of “3150” in the node #3.

(3) In the node #3, by looking up the mapping information based on the first LBA, the access management unit 16 identifies an LBA in the physical disk 21 associated with that first LBA.

Specifically, in the node #3, by looking up the mapping information, the access management unit 16 converts the first LBA into information identifying a storage device 21 (physical disk) and a second LBA in that storage device 21.

For example, by looking up the mapping information, the access management unit 16 in the node #3 obtains information identifying the storage device 21 corresponding to the first LBA “3150” and a second LBA of “150” in that storage device 21.

(4) In the node #3, the access management unit 16 carries out an access to the second LBA in the storage device 21 identified in the above processing (2).

Specifically, the access management unit 16 makes a data access (e.g., a read or a write) to the second LBA “150” in the storage device 21.

(D) Advantageous Effects

In accordance with the storage system 1 as one example of an embodiment, the time to log in to storage areas in multiple storage device provided in a remote node can be reduced.

As a result, the time to make iSCSI logins to storage areas in multiple storage devices 21 provided in the remote node 10 can be reduced. The consumption of the memory 106 used for the iSCSI login processing can also be reduced.

Particularly, in the storage system 1 of a shared-nothing configuration provided with multiple nodes 10, the time to make iSCSI logins to storage areas in multiple storage devices 21 provided in the remote node 10 can be reduced, and the consumption of the memory 106 used for the iSCSI login processing can also be reduced.

For example, even in a case where 1000 storage devices 21 are mounted under the control of each node 10, the time to make iSCSI logins can be reduced, and the consumption of the memory 106 used for the iSCSI login processing can also be reduced.

Furthermore, the concatenation volume creating unit 11 classifies the storage devices 21 into three groups in accordance with their disk access performances, and respective concatenation volumes 50 are created for those groups.

As a result, disk access processing of storage devices 21 with low disk access performances is prevented from negatively affecting processing of other storage devices 21 with high disk access performances. As a result, it is possible to achieve effective utilization of storage devices 21 with low disk access performances.

Since the configuration tables 15 are stored in non-volatile storage areas in the flash memory 107 or the like, it is possible to configure concatenation volumes 50 once again using the configuration tables 15 after a node 10 is powered off.

(E) Miscellaneous

The disclosed technique is not limited to the above-described embodiment, and may be embodied in various modification without departing from the spirit of the present embodiment. The configurations and processing in the present embodiment may be suitably selected or may be combined where appropriate.

For example, while the concatenation volume creating unit 11 creates conversion information (online_contact_table) based on information in the configuration tables 15 in the above-described embodiment, the name and the format of the conversion information may be suitably modified.

Furthermore, while the concatenation volume creating unit 11 creates a concatenation volume 50 by loading the conversion information into the dmsetup command, this is not limiting and a concatenation volume 50 may be created by loading information of the configuration tables 15 into the dmsetup command using any other techniques.

While the concatenation volume creating unit 11 classifies multiple storage devices 21 into three groups of the high speed group, the middle speed group, and the low speed group in the above-described embodiment, this is not limiting. For example, the multiple storage devices 21 may be classified into less than or more than three groups in accordance with their disk access performances and respective concatenation volumes 50 may be created for those groups.

Alternatively, the multiple storage devices 21 may be classified into multiple groups in accordance with a criteria other than the disk access performances.

The order of the steps in the flowchart in FIG. 15 may be suitably modified.

Further, the numbers and configurations of nodes 10, DEs 20, and storage devices 21, provided in the storage system 1, may be suitably modified.

The present embodiment may be practiced or manufactured by those skilled in the art based on the above disclosures.

In accordance with one embodiment, the time to log in to storage areas in multiple storage device provided in another node can be reduced.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a virtual integrated disk creating unit configured to create a single virtual integrated disk by virtually integrating storage areas of a plurality of storage devices; and
a target setting unit configured to set a login target to which a login to the virtual integrated disk from an outside is made.

2. The information processing apparatus according to claim 1, further comprising a fixation processing unit configured to fix respective unique device names to the plurality of storage devices,
wherein the virtual integrated disk creating unit is configured to integrate the storage areas of the plurality of storage devices using the fixed device names.

3. The information processing apparatus according to claim 1, wherein the virtual integrated disk creating unit is configured to classify the plurality of storage devices into a plurality of groups in accordance with disk access performances, and create respective virtual integrated disks for each of the plurality of groups by creating the virtual integrated disks with a plurality of storage devices classified in each group.

4. A storage system comprising:
a storage server configured to manage data accesses to a plurality of storage devices; and
an information processing apparatus,
the storage server comprising:
a virtual integrated disk creating unit configured to create a single virtual integrated disk by virtually integrating storage areas of the plurality of storage devices; and
a target setting unit configured to set a login target to which a login to the virtual integrated disk from an outside is made, and
the information processing apparatus comprising:
a login processing unit configured to execute a login for the login target that is set by the target setting unit.

5. The storage system according to claim 4, wherein
the storage server further comprises a fixation processing unit configured to fix respective unique device names to the plurality of storage devices, and
the virtual integrated disk creating unit is configured to integrate the storage areas of the plurality of storage devices using the fixed device names.

6. The storage system according to claim 4, wherein the virtual integrated disk creating unit is configured to create respective virtual integrated disks for each of the plurality of groups, by classifying the plurality of storage devices into a plurality of groups in accordance with disk access performances, and creating the virtual integrated disks with a plurality of storage devices classified in each group.

7. The storage system according to claim 4, further comprising a plurality of storage servers configured to manage respective data accesses to the plurality of storage devices, and
the plurality of storage servers are configured to create respective virtual integrated disks by virtually integrating storage areas of the plurality of storage devices.

8. A computer-readable recording medium having a control program recorded therein, the control program causing a computer to execute the processing to:
create a single virtual integrated disk by virtually integrating storage areas of a plurality of storage devices; and
set a login target to which a login to the virtual integrated disk from an outside is made.

9. The computer-readable recording medium to claim 8, wherein the control program causes the computer to execute the processing to:
fix respective unique device names to the plurality of storage devices; and
integrate the storage areas of the plurality of storage devices using the fixed device names.

10. The computer-readable recording medium to claim 8, wherein the control program causes the computer to execute the processing to:
classify the plurality of storage devices into a plurality of groups in accordance with disk access performances, and create respective virtual integrated disks for each of the plurality of groups by creating the virtual integrated disks with a plurality of storage devices classified in each group.

11. A method of controlling a storage in a storage system comprising a storage server configured to manage data accesses to a plurality of storage devices, and an information processing apparatus, the method comprising,
by the storage server:
creating a single virtual integrated disk by virtually integrating storage areas of the plurality of storage devices; and
setting a login target to which a login to the virtual integrated disk from an outside is made, and
by the information processing apparatus,
executing a login for the login target that is set.

12. The method of controlling a storage according to claim 11, further comprising, by the storage server:
fixing respective unique device names to the plurality of storage devices; and
integrating the storage areas of the plurality of storage devices using the fixed device names.

13. The method of controlling a storage according to claim 11, further comprising, by the storage server, classifying the plurality of storage devices into a plurality of groups in accordance with disk access performances, and creating respective virtual integrated disks for each of the plurality of groups by creating the virtual integrated disks with a plurality of storage devices classified in each group.

14. The method of controlling a storage according to claim 11, wherein, in a plurality of storage servers configured to manage respective data accesses to the plurality of storage devices, by the plurality of storage servers, creating respective virtual integrated disks by virtually integrating storage areas of the plurality of storage devices.
